(19) United States
(12) Patent Application Publication
(10) Pub. No.: US 2013/0127723 A1
(43) Pub. Date: May 23, 2013

(54) COLLAPSIBLE TRACKBALL

(71) Applicant: International Business Machines Corporation, Armonk, NY (US)

(72) Inventors: Minoru Kida, Sagamihara-shi (JP); Aya Minami, Fujisawa-city (JP); Yohichi Miwa, Yokohama (JP); Yasuhiro Yamamoto, Kawasaki-shi (JP)

(73) Assignee: International Business Machines Corporation, Armonk, NY (US)

(21) Appl. No.: 13/646,869

(22) Filed: Oct. 8, 2012

(30) Foreign Application Priority Data
Nov. 18, 2011 (JP) 2011253212

(51) Int. Cl. G06F 3/033

(52) U.S. Cl. 345/167

(57) ABSTRACT

Some embodiments of the inventive subject matter may include a trackball to provide input to electronic computing device. The trackball can include and upper portion having an upper surface. The trackball can include a lower portion having a lower surface. The lower portion can be operatively connected to the upper portion, wherein the upper portion can combine with the lower portion to form a complete sphere, and wherein the upper portion can be housed inside the lower portion in a collapsed position.

### RELATED APPLICATIONS

This application is based on and claims the benefit of priority from Japanese Patent Application No. 2011253212, filed on Nov. 18, 2011, the contents of which are incorporated by reference.

### BACKGROUND

Embodiments of the inventive subject matter generally relate to the field of electronic computing device input mechanisms, and more particularly to trackball input mechanisms.

Electronic computing devices can include many different input mechanisms. Common input mechanisms typically include hard and soft buttons, touchscreens, trackpads, mice, and trackballs. For example, a laptop computer may have both a trackpad and hard buttons. Alternatively, a laptop computer, or mobile phone, may have a trackball in addition to a plurality of hard and soft buttons.

Trackballs are a desirable input mechanism because of their ease of use. To retain this ease of use, it is often necessary for the trackball to be of sufficient diameter. This can pose a problem with today's technological advances creating slimmer and slimmer electronic computing devices. For example, the thickness of a laptop computer may limit the diameter of the trackball, or the diameter of the trackball may dictate the thickness of the laptop computer.

### SUMMARY

A component reduced in size and thickness has been mountable on a diagnostic ultrasound system, which is a medical device and industrial instrument, and a portable product thereof has appeared. A trackball, which is one of mechanical elements, cannot be reduced in thickness from a viewpoint of a user interface, which inhibits the reduction in thickness of a device. For example, the invention disclosed in Patent Document 1 requires at least a thickness for a trackball, which leads to a limitation in reduction in thickness of a device.

Therefore, it is an object of the present invention to provide a trackball which is able to be used directly as a user interface and enabling a reduction in thickness of an information device.

In order to achieve the above object, the present invention provides a trackball for manipulating a cursor displayed on a screen of an information device, including: a ball separated into an upper part and a lower part, which is capable of storing the upper part in the inside thereof, and formed by an overlap and engagement between an edge of the upper part and an edge of the lower part; and a cam mechanism which connects the lower part to the upper part, the cam mechanism being provided in the inside of the lower part so as to be able to lock the upper part in a position close to the bottom of the lower part in the inside thereof by pushing down the upper part and to return the upper part to the initial position by pushing down the upper part again to release the lock, wherein the upper part is:

1. in a stored state
pushed down in the diameter direction of the ball and locked with being pushed down by the cam mechanism to maintain the state of being stored inside the lower part; and
2. in an in-use state
pushed down in the diameter direction of the ball and then released from the lock where the upper part is pushed down by the cam mechanism and pushed up in the diameter direction by an elastic force of the cam mechanism, by which the edge of the upper part engages with the edge of the lower part so as to maintain a spherical configuration against a given pressure applied from the outside of the ball.

In the above, the trackball has a tapered engagement surface between the edge of the lower part and the upper part and a joint surface between the edges of the upper part and the lower part forms a smooth spherical surface.

Moreover, the trackball has the surface of the upper part which is separated from the surface of the lower part by color so that the upper part is identifiable.

Moreover, the present invention is an information device including the aforementioned trackball.

In addition, the information device has an upper-side unit including a display unit and a lower-side unit including an input unit (a keyboard having character keys, function keys, and a trackball). The input unit includes the trackball and the upper-side unit and the lower-side unit are foldable.

Further, the information device is characterized in that, in the state where the upper-side unit and the lower-side unit are opened, the upper part in the stored state is pushed down in the diameter direction so as to release the lock of the cam mechanism and the upper part is pushed up in the diameter direction so that the edge of the upper part is pressed against and engaged with the edge of the lower part to resume the spherical configuration of the ball and to maintain the spherical configuration against the given pressure applied from the outside of the ball to the upper part, and when the upper part and the lower part are folded, the upper part in the in-use state is pushed down and stored into the inside of the lower part by the locking function of the cam mechanism.

Still further, the information device is characterized in that an inner surface of the upper-side unit, in the state where the upper-side unit and the lower-side unit are folded, does not contact the top of the upper part in the stored state of the trackball.

Moreover, the cam mechanism of the trackball is a heart cam provided inside the lower part.

The reduction in thickness of the information device can be achieved by mounting a trackball having the above structure.

### BRIEF DESCRIPTION OF THE DRAWINGS

The present embodiments may be better understood, and numerous objects, features, and advantages made apparent to those skilled in the art by referencing the accompanying drawings.

FIG. 1 is a perspective view of a laptop computer 33 having a trackball 20 input mechanism.

FIG. 2 is an overhead view of a laptop computer 33 having a trackball 20 input mechanism.

FIG. 3 is a cross-sectional view of a laptop computer 33 having a trackball 20 input mechanism, showing the interference between the trackball 20 and the lid 10 of the laptop computer 33.

FIG. 4 is a cross-sectional view of a laptop computer 33, showing one embodiment of the inventive subject matter wherein the trackball 20 does not interfere with the lid 10 of the laptop computer 33.

FIG. 5 depicts one embodiment of the inventive subject matter wherein the trackball 20 is in the expanded position.

FIG. 6 depicts one embodiment of the inventive subject matter wherein the trackball 20 is in the collapsed position.

### DESCRIPTION OF EMBODIMENT(S)

Some embodiments of the inventive subject matter include a relatively large diameter collapsible trackball that facilitates user input on a computing device. Because the trackball is collapsible, some embodiments can employ a larger diameter trackball than if a traditional, non-collapsible, trackball were used. In one embodiment, the trackball may comprise and upper portion and a lower portion. The upper portion may be a portion created from dissecting the trackball above its equator. The result may yield an upper portion of the trackball that can be housed inside the lower portion of the trackball, decreasing the storage height of the trackball. In such embodiments, an electronic computing device may be able to include a trackball with a diameter close to, as large as, or larger than, the thickness of the electronic computing device.

The description that follows includes exemplary systems, methods, techniques, instruction sequences and computer program products that embody techniques of the present inventive subject matter. However, it is understood that the described embodiments may be practiced without these specific details. For instance, although examples refer to the upper portion of the trackball being housed within the lower portion of the trackball when collapsed, in other embodiments, the lower portion of the trackball may be housed in the upper portion of the trackball when collapsed. In other instances, well-known instruction instances, protocols, structures and techniques have not been shown in detail in order not to obfuscate the description.

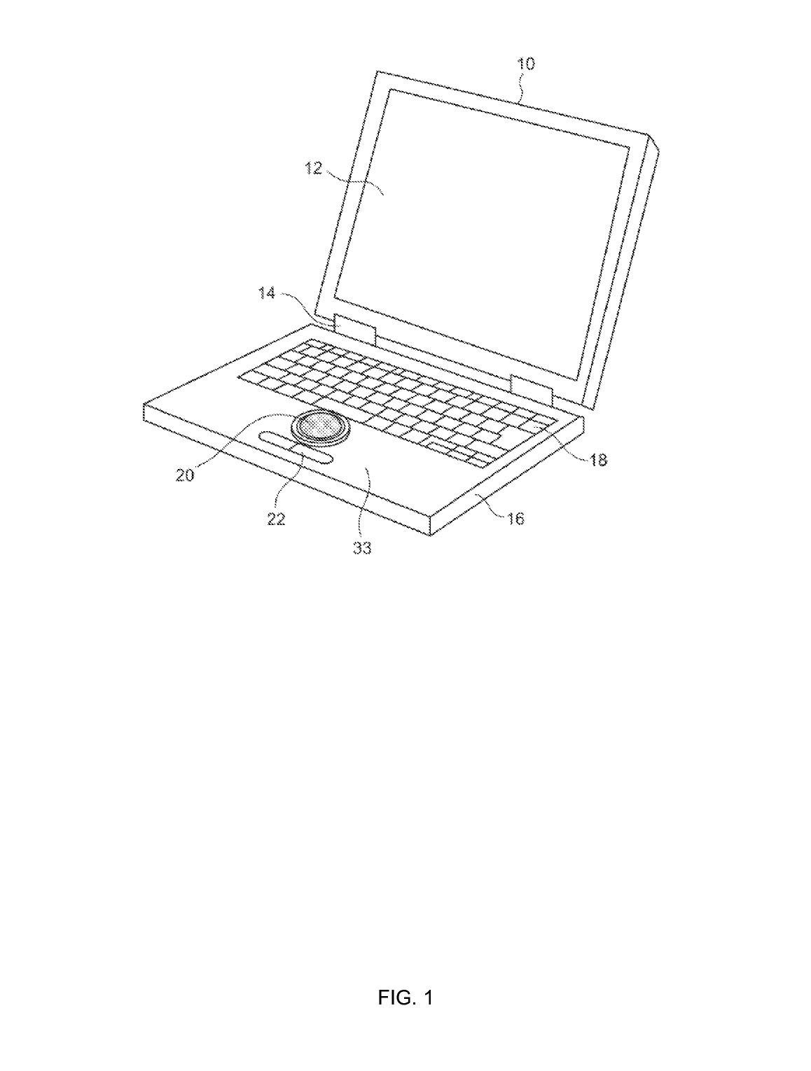

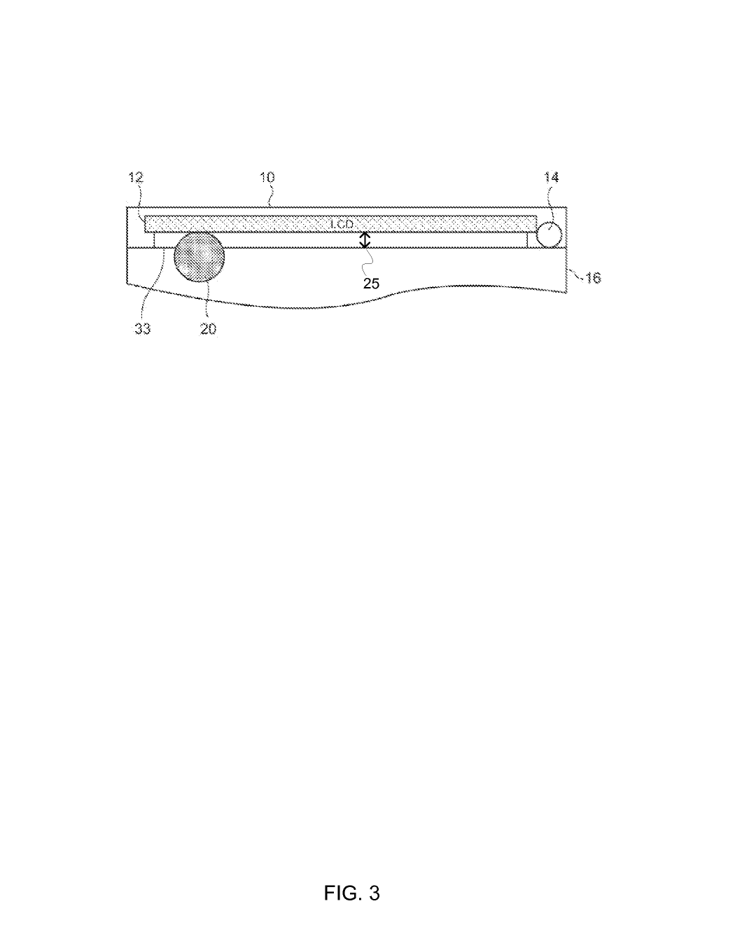

FIG. 1 is a perspective view of a laptop computer 33 having a trackball 20 input mechanism. In the depicted embodiment, the laptop computer 33 also includes a lid 10 containing a display device 12 (e.g. a liquid crystal display (LCD) screen), base 16, hinge 14 connecting the lid 10 to the base 16, keyboard 18, and hard buttons 22. Manipulating the trackball 22 may allow a user to navigate a cursor on the electronic computing device 33. The lid 10 is foldably connected via the hinge 14 to the base 16, as shown in FIG. 3.

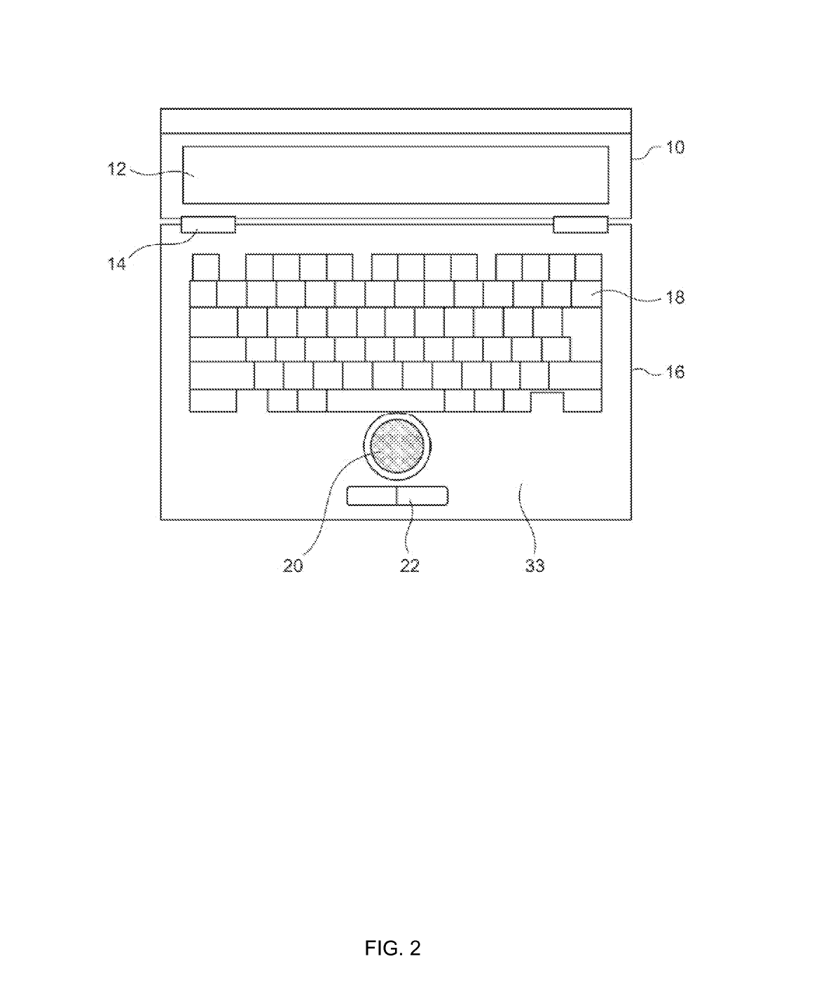

FIG. 2 is an overhead view of a laptop computer 33 having a trackball 20 input mechanism. In the depicted embodiment, the laptop computer 33 also includes a lid 10 containing a display device 12 (e.g. a liquid crystal display (LCD) screen), base 16, hinge 14 connecting the lid 10 to the base 16, keyboard 18, and hard buttons 22. Manipulating the trackball 22 may allow a user to navigate a cursor on the electronic computing device 33. The lid 10 is foldably connected via the hinge 14 to the base 16, as shown in FIG. 3.

FIG. 3 is a cross-sectional view of a laptop computer 33 with the lid 10 closed having a trackball 20 input mechanism, showing the interference between the trackball 20 and the lid 10 of the laptop computer 33. As shown, the lid 10 is rotated about hinge 14, to close the laptop computer 33. When a traditional, non-collapsible trackball 20 is used, the trackball 20 prevents the lid 10 from closing, and resting completely on the base 16 (see gap 25 between the base 16 and the display device 12). Rather, the diameter of the non-collapsible trackball 20 requires the display device 12 to be recessed inside the lid 10, creating the gap 25 between the lid 10 and the display device 12. Consequently, the thickness of the laptop computer 33 is dependent on the diameter of the trackball 20.

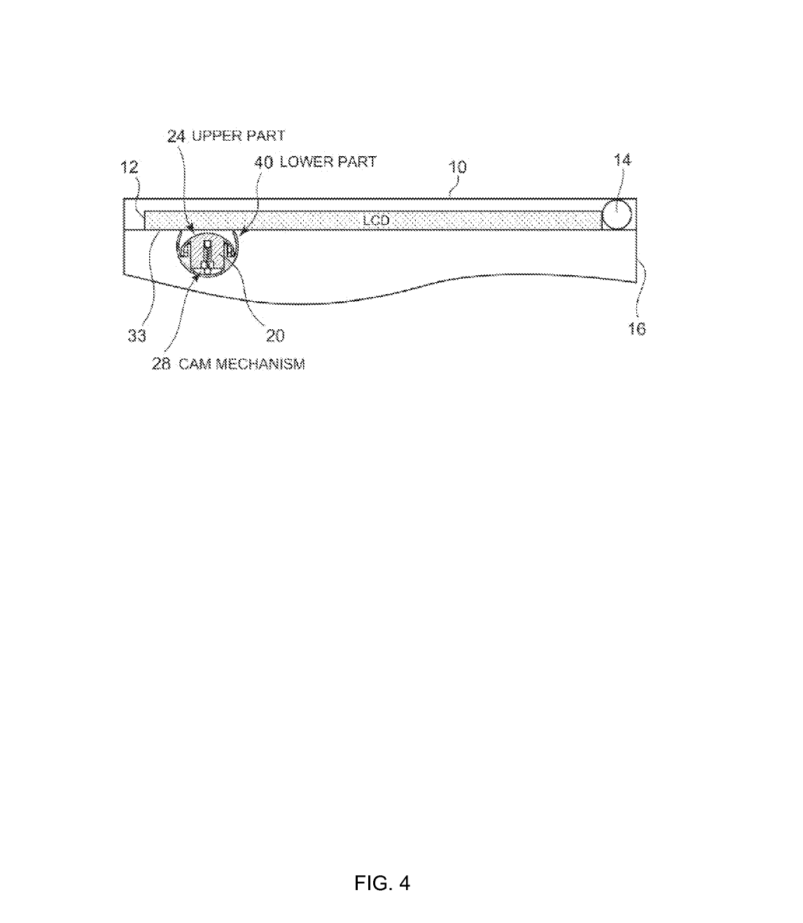

FIG. 4 is a cross-sectional view of a laptop computer 33, showing one embodiment of the inventive subject matter wherein the trackball 20 does not interfere with the lid 10 of the laptop computer 33. In the shown embodiment, the trackball 20 is collapsible. The upper portion 24 of the trackball 20 fits within the lower portion 40 of the trackball 20. Such modification allows the lid 10 to rest completely on the base 16 of the laptop computer 33. In some embodiments, the trackball 20 may contain a cam mechanism 28 to facilitate the collapsing and expanding of the trackball 20. The upper portion 24 of the trackball 20 is connected to the lower portion 40 of the trackball 20 by the cam mechanism 28.

The cam mechanism 28 may be a heart cam, rotating cam, cylindrical cam, etc. In some embodiments, the cam mechanism 28 has two “locked” positions—an extended position and a collapsed position. When the trackball 20 is in use, it will be in the extended position. When the lid 10 of the laptop computer 33 is closed, the trackball 20 will be in the closed position.

In some embodiments, the expanding and collapsing function may be achieved by pressing upper portion of the trackball 20. When the trackball 20 is in the expanded position, pressing the upper portion of the trackball 20 will cause the upper portion 24 of the trackball 20 to collapse and rest inside the lower portion 40 of the trackball 20. The trackball 20 will then be in the collapsed “locked” position. When the trackball 20 is in the collapsed position, pressing the upper portion 24 of the trackball 20 will cause the upper portion of the trackball 20 to reemerge from the lower portion 40 of the trackball 20. The trackball 20 will then be in the expanded “locked” position.

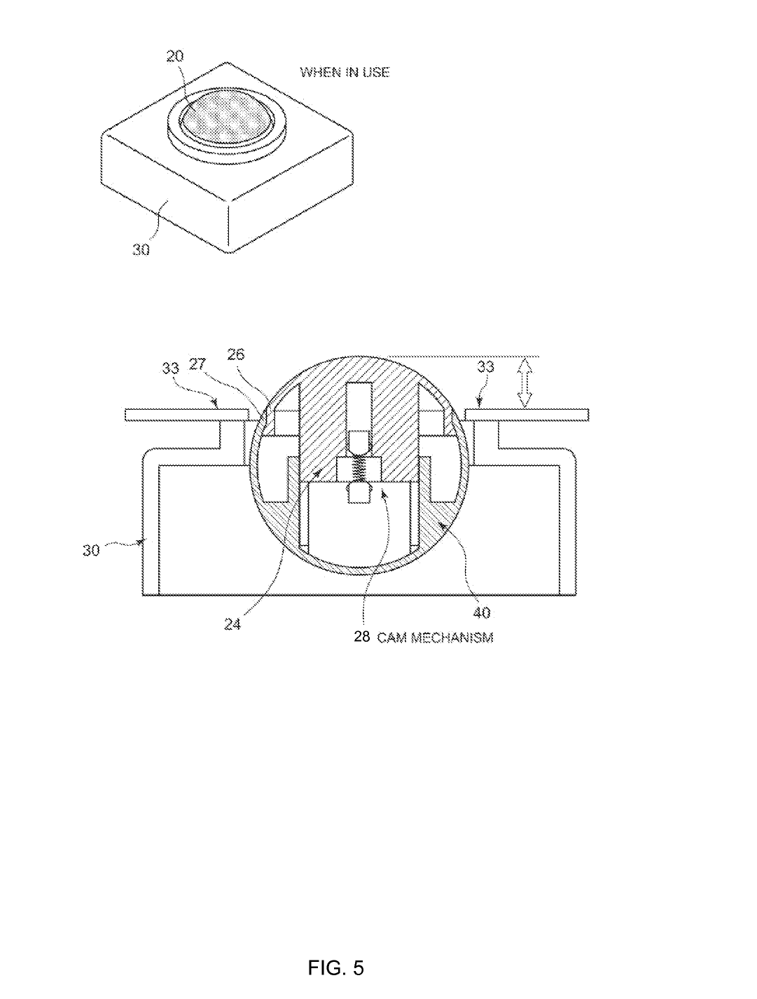

FIG. 5 depicts one embodiment of the inventive subject matter wherein the trackball 20 is in the expanded position. In the expanded position, the trackball 20 takes on a full spherical shape, allowing the user to manipulate the trackball 20 with ease to navigate the cursor on the laptop computer 33. As shown, the surface 26 of the upper portion 24 of the trackball 20 is flush with the surface 27 of the lower portion 40 of the trackball 20. The trackball 20 is seated in the trackball housing 30. The trackball housing 30 is seated within the laptop computer 33. The trackball 20 contains a cam mechanism 28. The cam mechanism 28 facilitates the collapse and expansion of the trackball 20 (as discussed in FIG. 4). In some embodiments, the contact surface 26 of the upper portion 24 of the trackball 20 and the lower portion 27 of the trackball 20 may be configured so the upper portion 24 of the trackball 20 is flush with the lower portion 27 of the trackball 20.

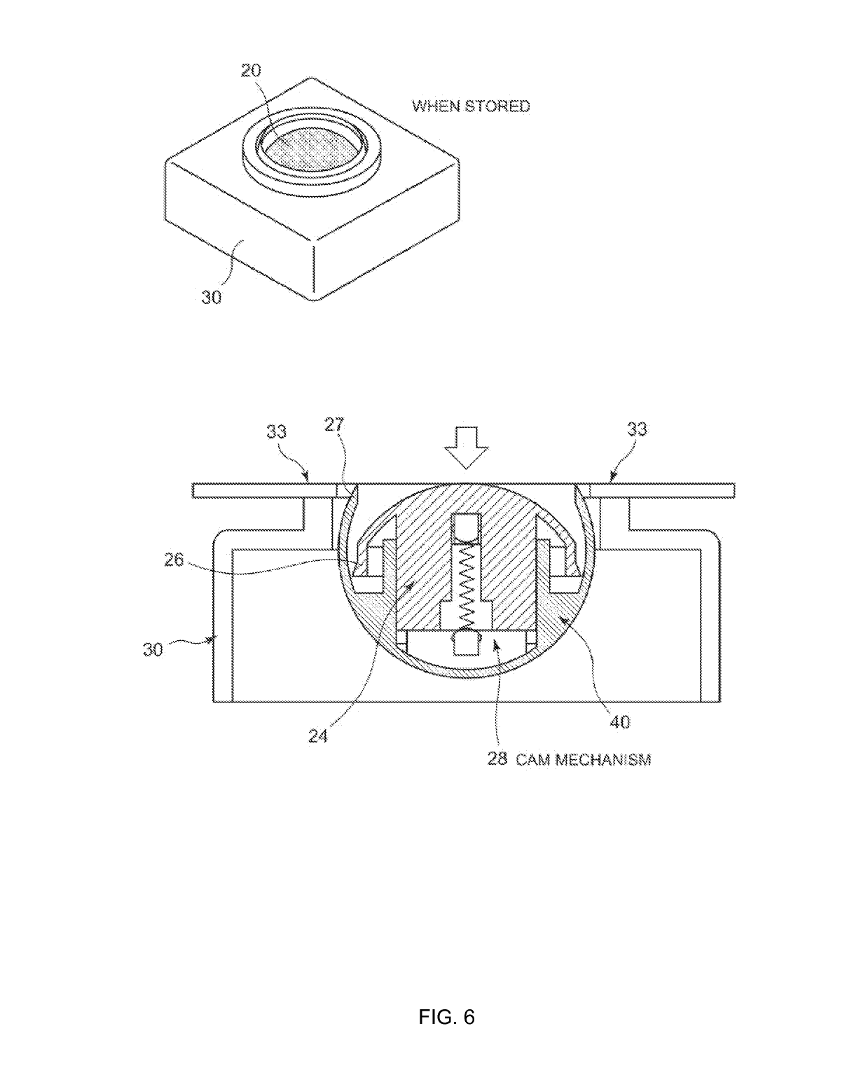

FIG. 6 depicts one embodiment of the inventive subject matter wherein the trackball 20 is in the collapsed position. In the collapsed position, the upper portion 24 of the trackball 20 rests inside the lower portion 27 of the trackball 20. In some embodiments, the trackball 20 in the collapsed position will not protrude above the trackball housing 30 as to not intersect the plane of the surface of the base of the laptop computer 33. The cam mechanism 28 connects the upper portion 24 of the trackball 20 to the lower portion 27 of the trackball 20. In some embodiments, the contact surface 26 of the upper portion 24 of the trackball may include a flange. This flange may prevent the trackball 20 from over expanding in the expanded position. In some embodiments, the surface of the upper portion 24 of the trackball 20 may be distinguishable from the surface of the lower portion 27 of the trackball 20, in order to assist the user in collapsing the trackball 20. For example, the surface of the upper portion 24 of the trackball 20 may be a different color than the surface of the lower portion 27 of the trackball 20. Alternatively, the surface of the upper portion 24 of the trackball 20 may distinguishable by texture, markings, etc.

What is claimed is:

1. A trackball to provide input to an electronic computing device, the trackball comprising;
an upper portion having an upper surface; and
a lower portion having a lower surface,
wherein the lower portion is operatively connected to the upper portion,
wherein the upper portion can combine with the lower portion to form a complete sphere, and
wherein the upper portion can be housed inside the lower portion in a collapsed position.

2. The apparatus of claim 1, wherein the upper portion is operatively connected to the lower portion by a cam.

3. The apparatus of claim 2, wherein the cam contains one or more springs.

4. The apparatus of claim 1, wherein the upper portion can be collapsed into the lower portion by applying pressure on the upper portion.

5. The apparatus of claim 1, wherein the upper portion can be expanded from the lower portion by applying pressure on the upper portion.

6. The apparatus of claim 1, wherein the upper portion is distinguishable from the lower portion.

7. The apparatus of claim 1, wherein the upper portion has a flange that engages the lower portion, preventing the surface of the upper portion from extending above the surface of the lower portion.

8. A trackball to provide input to an electronic computing device, the trackball comprising;
an upper portion having an upper portion surface;
a lower portion having a lower portion surface,
wherein the lower portion is operatively connected to the upper portion;
wherein the trackball is configured to move into an expanded position wherein the upper portion is seated upon the lower portion forming a complete sphere; and
wherein the trackball is configured to move into a collapsed position wherein the upper portion is housed inside the lower portion.

9. The apparatus of claim 8, wherein the upper portion is operatively connected to the lower portion by a cam.

10. The apparatus of claim 9, wherein the cam contains one or more springs.

11. The apparatus of claim 8, wherein the upper portion can be collapsed into the lower portion by applying pressure on the upper portion.

12. The apparatus of claim 8, wherein the upper portion can be expanded from the lower portion by applying pressure on the upper portion.

13. The apparatus of claim 8, wherein the upper portion is distinguishable from the lower portion.

14. The apparatus of claim 8, wherein when in the expanded position, the upper portion surface is flush with the lower portion surface.

15. The apparatus of claim 8, wherein the upper portion has a flange that engages the lower portion, preventing the surface of the upper portion from extending above the surface of the lower portion.

16. An electronic computing device comprising;
a trackball configured to receive user input, the trackball having an upper portion and a lower portion, wherein the upper portion is configurable to store within the lower portion; and
a processor connected to the trackball, the processor configured receive the user input from the trackball, and to provide the user input to programs on the computing device.

17. The electronic computing device of claim 16 is configured to open into an expanded position in which the upper portion of the trackball rests on top of the lower portion of the trackball forming a complete sphere.

18. The electronic computing device of claim 16, wherein the upper portion of the trackball is operatively connected to the lower portion of the trackball by a cam.

19. The electronic computing device of claim 18 wherein the cam contains one or more springs.

20. The apparatus of claim 16, wherein the upper portion has a flange that engages the lower portion, preventing the surface of the upper portion from extending above the surface of the lower portion.
